(19) United States
(12) Patent Application Publication
(10) Pub. No.: US 2024/0288577 A1
(43) Pub. Date: Aug. 29, 2024

(54) Ultrasonic Detection Device

(71) Applicants: Wanjiong Lin, Ningbo (CN); Self Electronics Co., Ltd., Ningbo (CN); Self Electronics USA Corporation, Norcross, GA (US)

(72) Inventors: Wanjiong Lin, Ningbo (CN); Linji Wang, Ningbo (CN); Ke Wang, Ningbo (CN); Hui Chen, Ningbo (CN); Jiayun Dai, Ningbo (CN)

(21) Appl. No.: 18/585,435

(22) Filed: Feb. 23, 2024

(30) Foreign Application Priority Data
Feb. 26, 2023 (CN) 202310191468.2

(51) Int. Cl. G01S 15/62; G01S 7/521; G01S 15/18

(52) U.S. Cl. CPC G01S 15/62; G01S 7/521; G01S 15/18

(57) ABSTRACT

An ultrasonic detection device has an ultrasonic probe, which transmits ultrasonic waves and receives echoes; a reflector, arranged spaced apart from the ultrasonic probe, which redistributes the energy of the ultrasonic wave to change the detection range of the ultrasonic wave. The ultrasonic detection method changes from original direct type to a horizontal type, optimizes the ultrasonic detection range to adapt to the actual detection space, and improves the accuracy of the detection.

### RELATED APPLICATION

This application claims priority to a Chinese Patent Application No. CN 202310191468.2, filed on Feb. 26, 2023.

### FIELD OF THE TECHNOLOGY

The invention relates to the technical field of ultrasonic detection, and in particular to an ultrasonic detection device.

### BACKGROUND

With the rapid development of the national economy and social progress, there are more and more places such as shopping plazas, stores, museums, tourist attractions, etc. The passenger flow is a very critical data for these places which can provide important reference for the management and decision-making of the operators. An ultrasonic detection device is installed at the entrance of the place for detecting the real-time passing passenger flow, and then feed back to the electrical appliances in the area, such as lamps, etc. By adjusting the lighting parameters of the lamps in real time, it can reduce power consumption when there are few people and avoid long-term power on.

Nowadays the control application of the existing lamps according to the passenger flow is still immature. Among them, some are single in controlling method and lamps' switching on the basis of whether or not people are passing by; some have introduced passenger flow monitoring and statistics mechanism by setting ultrasonic detectors at the entrance which emit ultrasonic waves downwards, then collecting passenger flow information to control the lamps according to the data collected.

The ultrasonic detectors use ultrasonic waves to detect passing passenger flow by means of time-based ranging. And the principle is as follows: a beam of ultrasonic waves is emitted from the ultrasonic transmitting end and the timing starts at the same time. The emitted ultrasonic waves propagate in the medium, and because acoustic waves have the characteristics of reflection, they will be reflected back when they encounter an obstacle. When the receiving end of the ultrasonic waves receive the reflected ultrasonic wave, the timing stops. When the medium is air, the speed of sound is 340 m/s. When the ultrasonic waves are launched to the ground, the detection area is corresponding to the area that the beam covers on the ground. When someone enters the detection area and is detected, the height of the person relative to the ground makes the time required to receive the reflected ultrasonic wave changes, so that it can be judged that someone has passed through the detection area.

Generally, the detection range of ultrasonic detectors is the coverage of the columnar acoustic beam projected onto the ground, and it is not possible to accurately control the detection area of a specific site. For example, for the flow of passengers entering the door, it is necessary to detect changes in the flow of passengers within the width of the door. However, generally the ultrasonic detector directly emits ultrasonic waves so that the coverage of the detection area on the ground is a circle or a near-circle, which is not able to match the width, and as a result it is easy to miss detecting the flow of passengers located at the edge of the range. In addition, along the direction of the entry and/or exit of the flow of passengers, the detection range of the circle is greater than the single stride distance of one person, and it is easy to include more than one person walking around at the same time, which does not achieve good discrimination. Therefore it is necessary to improve the discriminative ability for different individuals.

Accordingly, those skilled in the art endeavor to develop an ultrasonic detection device to match the specific detection range and to improve discriminative ability.

### SUMMARY OF THE INVENTION

In view of this, the present invention provides an ultrasonic detection device to solve the poor discrimination problem due to the large circular detection area of the existing ultrasonic detector.

To achieve the above object, the present invention provides an ultrasonic detection device, comprising:
an ultrasonic probe, which transmits ultrasonic waves and receives echoes;
   a reflector, arranged spaced apart from the ultrasonic probe, which redistributes the energy of the ultrasonic wave to change the detection range of the ultrasonic wave.

Optionally, the ultrasonic detection device is used for detecting the flow of people in a space, and the ultrasonic device is arranged above the entrance and/or exit pathway of the space to detect the flow of people passing through; and after ultrasonic waves pass and reflected by the reflector, the detection range along the direction of flow of people matches the striding distance, the detection range perpendicular to the direction of flow of people matched the width of the entrance and/or exit pathway of the space.

Optionally, the reflector stretches or shrinks the ultrasonic wave distribution range in a transverse direction of the detection area, or, alternatively, stretches or shrinks the ultrasonic wave distribution range in a longitudinal direction of the detection area, or, alternatively, readjusts the ultrasonic wave distribution range in multiple dimensions of the detection area.

Optionally, the space is a supermarket, a shopping mall, a store or a museum.

Optionally, the reflector comprises a reflecting surface.

Optionally, the reflecting surface comprises a convergence zone and/or a dispersion zone, the convergence zone causing the ultrasonic waves from the ultrasonic probe to converge along an X-axis direction and/or a Y-axis direction, and the dispersion zone causing the ultrasonic waves from the ultrasonic probe to disperse along the X-axis direction and/or the Y-axis direction.

In one embodiment of the present invention, the reflector is a reflecting plate, and along an X-axis direction and/or a Y-axis direction, the reflector is thicker in the middle and thinner on both sides, so that the ultrasonic waves from the ultrasonic probe can disperse along the corresponding direction.

In one embodiment of the present invention, the reflector is a reflecting plate, and along an X-axis direction and/or a Y-axis direction, the reflector is thinner in the middle and thicker on both sides, so that the ultrasonic waves from the ultrasonic probe can converge along the corresponding direction.

In one embodiment of the present invention, the ultrasonic probe is mounted along a horizontal direction, and the reflecting surface is provided at an outward inclination with respect to the ultrasonic probe, so that the reflecting surface reflects the ultrasonic waves coming from the ultrasonic probe and then propagates them downwards.

Optionally, an acoustic wave absorbing device is further comprised, and the acoustic wave absorbing device is arranged on the ultrasonic probe or on the reflector or in between.

Optionally, a mounting bracket is also provided for mounting the ultrasonic probe.

Optionally, the reflector is integrated with the mounting bracket.

The technical effects of the present invention:

The ultrasonic detection device of the present invention, firstly, by setting a reflector, changes the ultrasonic detection method from original direct type to a horizontal type, and the detection area also correspondingly from being perpendicular to being horizontal to the ultrasonic probe; secondly, by said different designs of the reflector's reflecting surface, it can readjust said horizontal detection from the original directly-emitted formed circular detection area to an elliptical one, with a dimensional change by the reflector, so as to adapt to the detection area corresponding to the stride distance and improve the detection accuracy.

### BRIEF DESCRIPTION OF THE DRAWINGS

Embodiments of the present invention will be described below with reference to the drawings, in which:

FIG. 1 is a structure schematic diagram of the place of implementation of the ultrasonic detection device of the present invention.

FIG. 2 is a structure schematic diagram of the ultrasonic detection device of the present invention in cross-section.

FIG. 3 is a structure schematic diagram of an embodiment of the ultrasonic detection device, wherein (a) is a three-dimensional structure schematic diagram, (b) is a first cross-sectional schematic diagram, and (c) is a second cross-sectional schematic diagram.

FIG. 4 is a schematic diagram of the working principle of the reflector of the present invention in an embodiment, showing how the ultrasonic signal is reflected at a first cross-section.

FIG. 5 is a schematic diagram of the structure of the ultrasonic detection device of the present invention provided with an acoustic wave absorbing device.

FIG. 6 is a schematic structural diagram of another embodiment of a reflector of the ultrasonic detection device of the present invention.

FIG. 7 is a schematic structural diagram of another embodiment of a reflector of the ultrasonic detection device of the present invention.

FIG. 8 is a schematic structural diagram of another embodiment of a reflector of the ultrasonic detection device of the present invention.

FIG. 9 is a schematic structural diagram of another embodiment of a reflector of the ultrasonic detection device of the present invention.

FIG. 10 is a schematic structural diagram of another embodiment of a reflector of the ultrasonic detection device of the present invention.

### DETAILED DESCRIPTION OF THE INVENTION

Specific embodiments of the present invention will be described in further detail below based on the drawings. It should be understood that the description of the embodiments of the present invention herein is not intended to limit the protection scope of the present invention.

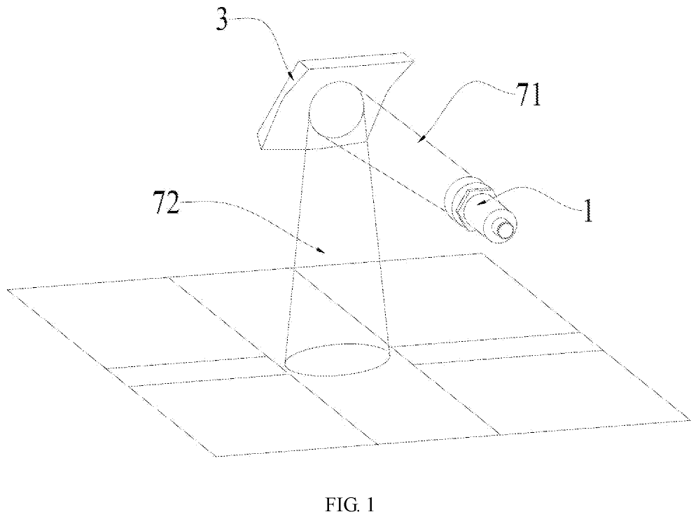

An ultrasonic detection device provided by the present invention is shown in FIGS. 1-4, the basic structure of which includes an ultrasonic probe 1 and a reflector 3. The ultrasonic probe 1 is used for transmitting ultrasonic waves and receiving echoes between the ultrasonic probe 1 and the detection area; the reflector 3 is fixedly mounted spaced apart from the ultrasonic probe 1, and is suitable for reflecting the ultrasonic waves, and redistributing the energy of the ultrasonic wave in order to change the detection range of the ultrasonic wave.

FIG. 1 illustrates the scene where the ultrasonic detection device of the present invention is used to detect a flow of people in a space. The ultrasonic device is arranged above the entrance and/or exit pathway of the space to detect the flow of people passing through. And after the ultrasonic waves pass and reflected by the reflector 3, the detection range along the direction of flow of people matches the striding distance, the detection range perpendicular to the direction of flow of people matched the width of the entrance and/or exit pathway of the space. Further, said space is a supermarket, a shopping mall, a store or a museum.

The striding distance of the flow of people refers to the average stride distance. Typically, the standard distance for a forward march is 75 cm in one step. The average stride distance for adults is about 70 cm. For applicable spaces such as shopping malls, supermarkets and stores, the striding distance of the flow of people can be obtained based on statistical laws combing spatial characteristics when people enter and exit.

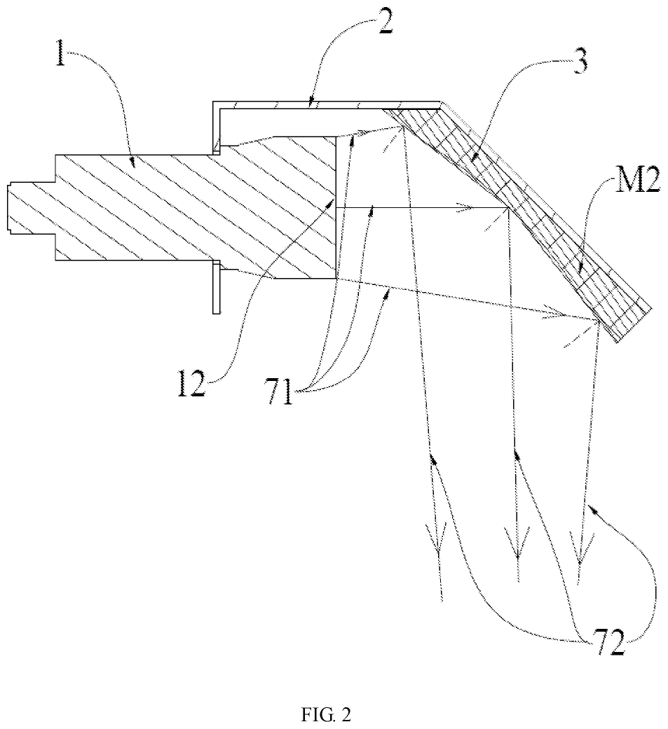

FIG. 2 shows a structural embodiment of the ultrasonic detection device of the present invention. The ultrasonic probe 1 comprises a probe portion 12 at the end thereof, which is suitable for transmitting and receiving ultrasonic waves; the mounting bracket 2 is suitable for fixedly connecting to the ultrasonic probe 1; the reflector 3 is fixedly mounted spaced apart from the ultrasonic probe 1, and is set at an outward inclination with respect to the ultrasonic probe 1, and has a length direction, i.e., an X-axis direction, and extends farther away from the probe portion 12 along the length direction X. And the reflector 3 comprises a reflecting surface 31 provided opposite the probe portion 12, which is suitable for reflecting ultrasonic waves. Preferably, the reflector 3 is fixedly connected to one end of the mounting bracket 2. Further, the reflecting surface 31 changes the propagation direction of the ultrasonic waves after reflecting the ultrasonic waves, e.g., ultrasonic waves originally propagating horizontally become vertically propagating after reflection. The reflecting surface 31 is made of materials suitable for reflecting the ultrasonic waves, such as stainless steel, acrylic, and the like.

Generally, the ultrasonic waves emitted from the ultrasonic probe 1 propagate along a straight line with a columnar propagation range. For example, when the outlet of the probe portion 12 is circular, the ultrasonic waves propagate in a conical region extending from the outlet, and when they reach the detection plane, the area covered in the plane is a projection of the aforesaid conical region on the detection plane, and the contour of the covered area is an enlarged circle or ellipse. The ultrasonic detection device of the present invention is improved by providing the reflector 3, which redirects the path of the ultrasonic waves emitted and received by the ultrasonic probe 1. Further, by designing the structure of the reflecting surface 31, the range covered by the ultrasonic waves is altered by reflecting the ultrasonic waves to accurately match the area that actually needs to be detected.

The reflecting surface 31 comprises a convergence zone and/or a dispersion zone, the convergence zone causing the ultrasonic waves from the ultrasonic probe 1 to converge along an X-axis direction and/or a Y-axis direction, and the dispersion zone causing the ultrasonic waves from the ultrasonic probe 1 to disperse along the X-axis direction and/or the Y-axis direction.

According to the shape of the reflecting surface 31 described above, its profile in the X-axis direction or the Y-axis direction can be varied to redistribute the energy of the ultrasonic waves.

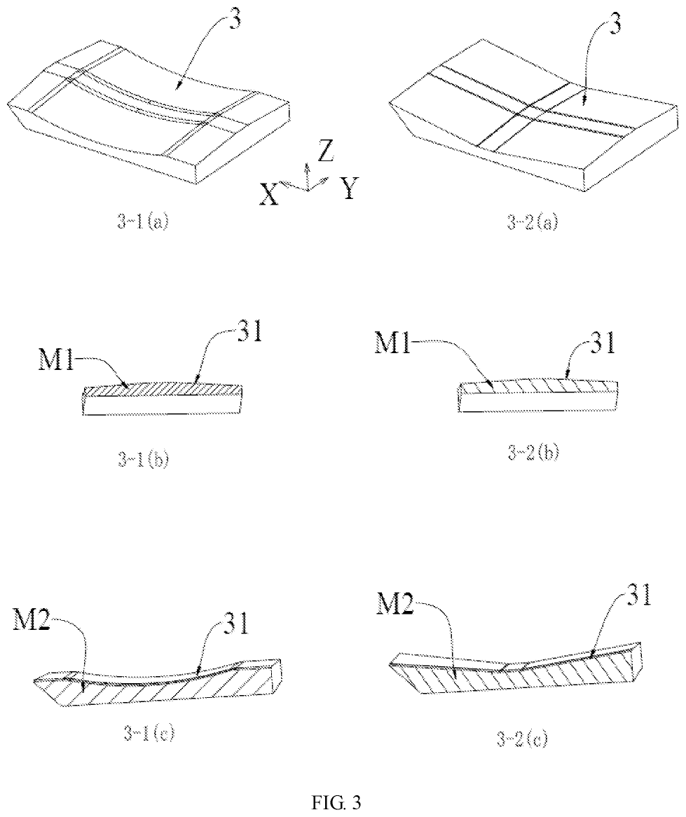

An exemplary embodiment of the reflector 3 in the present invention is provided as in FIG. 3. Defining a first cross-section M1 as a cross-section of the reflector 3 along a thickness direction Z (Z-axis direction) and a width direction Y (Y-axis direction), in the first cross-section M1, the middle part of the reflecting surface 31 forms a protrusion toward the probe portion 12, and the reflecting surface 31 gradually increases its distance away from the ultrasonic probe 1 from the middle part toward the two ends, thus to form a cross-section shape with a thick middle and two thin sides along the Y-axis direction. After the ultrasonic waves are reflected by the reflecting surface 31, the reflected wave 72 becomes wider in the Y-axis direction with respect to the incident wave 71, so that the ultrasonic waves from the ultrasonic probe 1 are dispersed along the Y-axis direction while the ultrasonic probe 1 is set unchanged. Then the detection width of the detection area is increased in the transverse direction, i.e., in the Y-axis direction. As another optional embodiment, a second cross-section M2 is defined as a cross-section of the reflector 3 along the thickness direction Z and the length direction X. In the second cross-section M2, the reflecting surface 31 is concave, i.e., a cross-section shape with two thick sides and a thin middle is formed along the X-axis direction, so that ultrasonic waves from the ultrasonic probe 1 converge along the X-axis direction. As shown in FIG. 3, two embodiments of the reflecting surface 31 are provided, exemplified in FIG. 3-1 and FIG. 3-2, having different contour shapes.

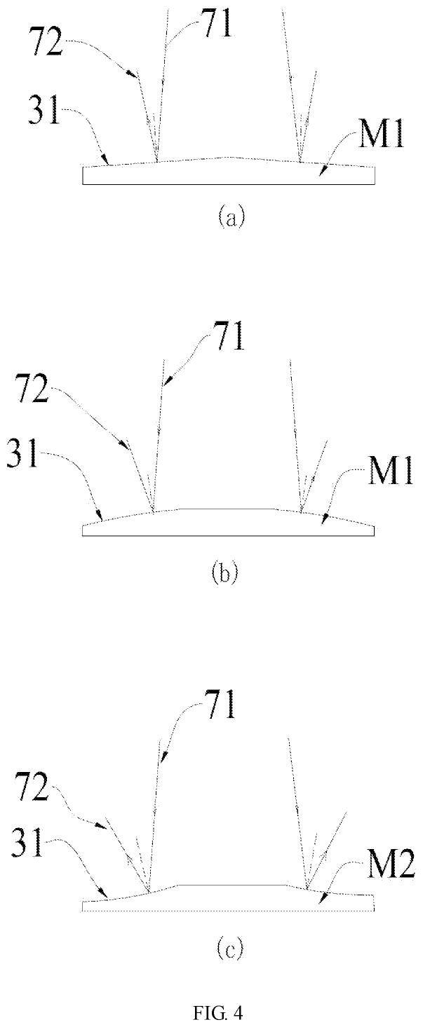

In the first cross-section M1, at least part of the profile of the reflecting surface 31 is a straight line or a curve, i.e., it can be a straight line, a curve or a combination thereof. In an embodiment as shown in FIG. 4(a), the reflecting surface 31 comprises two inclined planes, which are inclined from the middle to the both ends, and the incident wave 71 is reflected by the reflecting surface 31, then the reflected wave 72 is dispersed.

In another embodiment as shown in FIG. 4(b), the profile of the reflecting surface 31 in the first cross-section M1 is at least partly a curve, with the center of curvature of the curve being located externally on the back side of the reflecting surface 31. The reflecting surface 31 has a flat surface in the middle and connects curved surfaces at both ends, and the curved surfaces at both ends are curved outward. Thus after the incident wave 71 is reflected by the reflecting surface 31, the reflected wave 72 formed is dispersed.

In another embodiment as shown in FIG. 4(c), the profile of the reflecting surface 31 in the first cross-section M1 is at least partly a curve, with the center of curvature of the curve being located externally on the front side of the reflecting surface 31. The reflecting surface 31 has a flat surface in the middle and connects curved surfaces at both ends, and the curved surfaces at both ends are curved outward. Thus after the incident wave 71 is reflected by the reflecting surface 31, the reflected wave 72 formed is dispersed.

In addition, the profile of the reflector 3 in the first cross-section M1 can also be selected as a straight line, a concave line or a convex line, etc., depending on the different needs for ultrasonic wave distribution in the detection area in the transverse direction or in the width direction Y.

The ultrasonic signal transmitted by the ultrasonic probe 1 has a range close to a columnar shape and has certain dispersion characteristics, as shown in FIG. 2. From the second cross-section M2, after the signal is incident to the reflecting surface 31, because the reflecting surface 31 is designed in a concave shape, which can be designed as a concave curved surface, or as a combination of a plurality of flat surfaces, or as a combination of concave curved surfaces and flat surfaces. The above-described reflecting surface 31 makes the reflected wave 72 of the ultrasonic wave change from diverging to converging in the length direction X, and the dimension of ultrasonic detection in the longitudinal direction of the detection area is compressed.

Further, when the reflecting surface 31 is designed as a concave shape, the angle between the tangent direction at any point of the contour line on the second cross-section M2 and the emission direction of the ultrasonic signal is an acute angle, and the angle tends to gradually increase toward the end that is away from the probe portion 12, so that a convergence effect can be realized after reflecting the incident ultrasonic waves by the above-mentioned concave reflecting surface 31.

In addition, the reflector 3 can be selected to have its profile in the second cross-section M2 as a straight line, a concave line or a convex line, etc., according to the different needs of the detection area in the longitudinal direction or in the length direction X for the distribution of the ultrasound waves.

In view of the above structure, the ultrasonic detection device of the present invention redistributes the range of ultrasonic waves in the detection area by means of the reflector 3. To stretch or shrink the ultrasonic wave distribution range in the transverse direction of the detection area, or to stretch or shrink the ultrasonic wave distribution range in the longitudinal direction of the detection area, or to change the distribution of ultrasonic waves in different dimensions of the detection area at the same time, the realization of the above technical effect needs to be achieved by setting the reflecting surfaces 31 of the reflector 3 in different shapes. And the reflecting surfaces 31 can be set in a symmetrical shape, or can be set in an asymmetrical shape.

When the ultrasonic detection device is used, it is required that the ultrasonic probe 1 and the reflector 3 do not move relative to the mounting bracket 2, and therefore both can be fixedly mounted with the mounting bracket 2. In the embodiment shown in FIG. 2, the reflector 3 is fixedly attached to an end of the mounting bracket 2. Optionally, the reflector 3 is a reflecting plate, and the reflecting plate is fixed to the mounting bracket 2 by means of bonding, welding, or fastener connections.

Preferably, the reflector 3 is integrally formed at the end of the mounting bracket 2, i.e., the reflecting surface 31 is obliquely formed at the end of the mounting bracket 2 to reflect the ultrasonic waves from the ultrasonic probe 1.

The ultrasonic probe 1 of the present invention is a prior art. For example, the probe portion 12 is used for transmitting and receiving ultrasonic waves. Components for energy conversion and signal amplification are set inside the housing of the ultrasonic probe. A control board is set in the mounting bracket 2 and connected to the ultrasonic probe 1 for controlling the whole working system, for example, firstly, controlling the probe portion 12 to transmit the ultrasonic waves, and then judging the ultrasonic waves received by the probe portion 12, and determining whether or not the received ultrasonic waves are transmitted by the ultrasonic waves emitted by itself, and finally recognizing the magnitude of the received ultrasonic waves.

The ultrasonic probe 1 has different structures, which can be categorized as a straight probe, an oblique probe, a surface wave probe, a Lamb wave probe, a dual probe (one for transmitting and one for receiving), etc., those skilled in the art can select specific implementations in accordance with the disclosed technology, and will not be specifically limited herein.

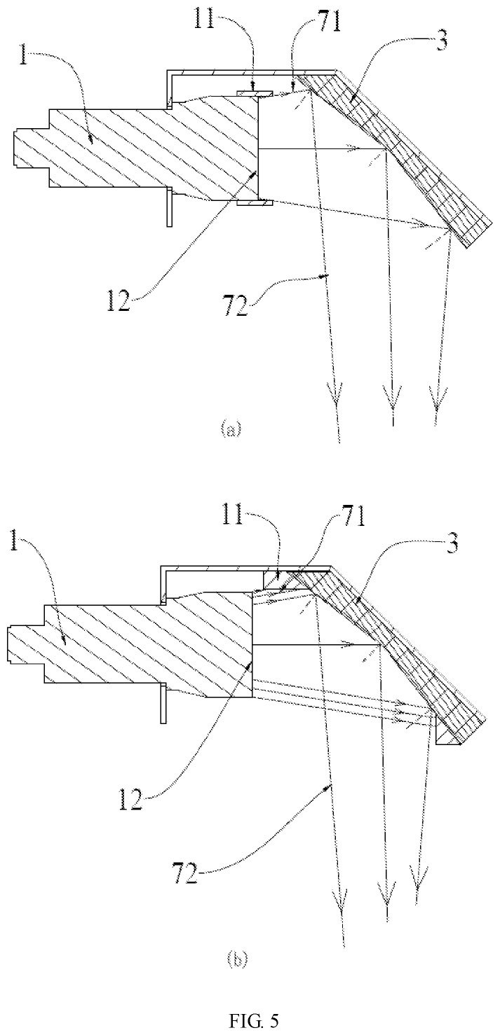

Further, as shown in FIG. 5, an acoustic wave absorbing device 11 is further comprised. The acoustic wave absorbing device 11 is arranged on the ultrasonic probe 1 (as in FIG. 5a) or on the reflector 3 (as in FIG. 5b) or in between, and which is disposed in the ultrasonic transmission path between the ultrasonic probe 1 and the reflector 3 and/or in the ultrasonic outgoing direction of the reflector 3. The acoustic wave absorbing device 11 has a cross-section that is elliptical, rectangular, ellipsoid-like or rectangular-like, and the acoustic wave absorbing device 11 is provided to further limit or change the range of acoustic wave propagation.

In one application of the present invention, the ultrasonic probe 1 mounted along a horizontal direction, and the reflecting surface 31 is provided at an outward inclination with respect to the ultrasonic probe 1, so that the reflecting surface 31 reflects the ultrasonic waves coming from the ultrasonic probe 1 and then propagates them downwards.

According to the ultrasonic detection device described above, when in use, the ultrasonic detection device can be mounted above the pathway. The reflector 3 reflects the ultrasonic waves toward the ground of the pathway, and, the ultrasonic waves returning from the ground are then received by the ultrasonic probe 1 after reflected by the reflector 3. By setting the shape of the reflector 3 on the first cross-section M1 and the second cross-section M2, the detection area of the ultrasonic waves is adjusted to adapt to the pathway, and the detection width is able to cover a range of transverse width of the pathway, so as to prevent pedestrians at the edges of the pathway from being missed. According to the structure of the reflector 3 as shown in FIG. 3, along the direction a person walks back and forth, the detection range in the longitudinal direction of the pathway is then narrowed down enough to allow a single person to enter the detection range in the longitudinal direction one by one. And the detection range along the direction of flow of people in and out of the pathway is matched with the striding distance, which significantly reduces the probability of detecting adjacent pedestrians in the front and rear directions at the same time, and strengthens the ability of ultrasonic discernment of pedestrians in the front and rear directions. Accordingly, with the ultrasonic detection device of the present invention, it is possible to more accurately detect pedestrians passing through the pathway, and it is particularly suitable for passenger flow statistics in supermarkets, shopping malls, stores or museums.

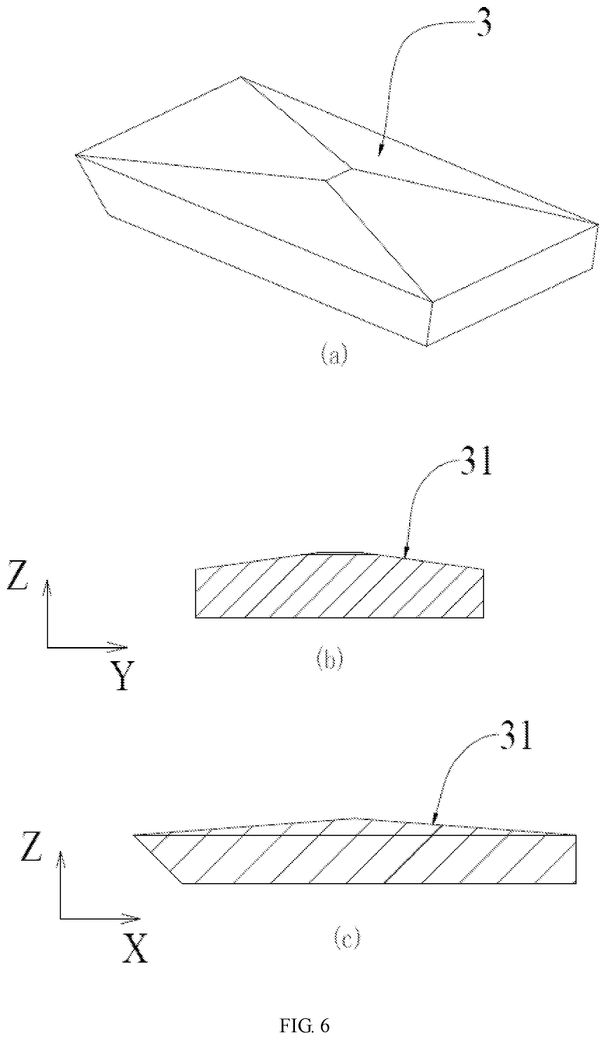

For different applications, the different structures of the reflector 3 in the ultrasonic detection device of the present application can lead to a variety of changes in the ultrasonic energy distribution, as shown in FIGS. 6 to 10 as exemplary illustrations of different applications of the reflector 3:

As shown in the structure of the reflector 3 in FIG. 6, the middle of the reflector 3 along the Y-axis direction is thick and the sides are thin, so as to cause the ultrasonic waves from the ultrasonic probe 1 to disperse along the Y-axis direction; and the middle of the reflector 3 along the X-axis direction is thick and the sides are thin, so as to cause the ultrasonic waves from the ultrasonic probe 1 to disperse along the X-axis direction. The above-structured reflector 3 causes the ultrasonic waves to disperse along various dimensions.

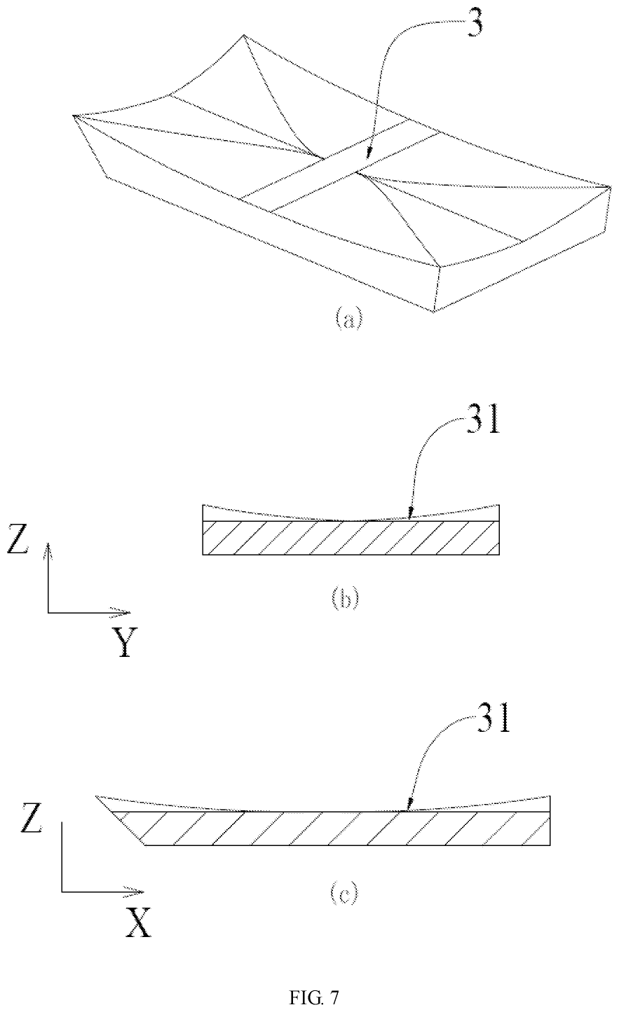

As shown in the structure of the reflector 3 in FIG. 7, the middle of the reflector 3 along the Y-axis direction is thin and the sides are thick, so as to cause the ultrasonic waves from the ultrasonic probe 1 to converge along the Y-axis direction; and the middle of the reflector 3 along the X-axis direction is thin and the sides are thick, so as to cause the ultrasonic waves from the ultrasonic probe 1 to converge along the X-axis direction. The above-structured reflector 3 causes ultrasonic waves to converge along various dimensions.

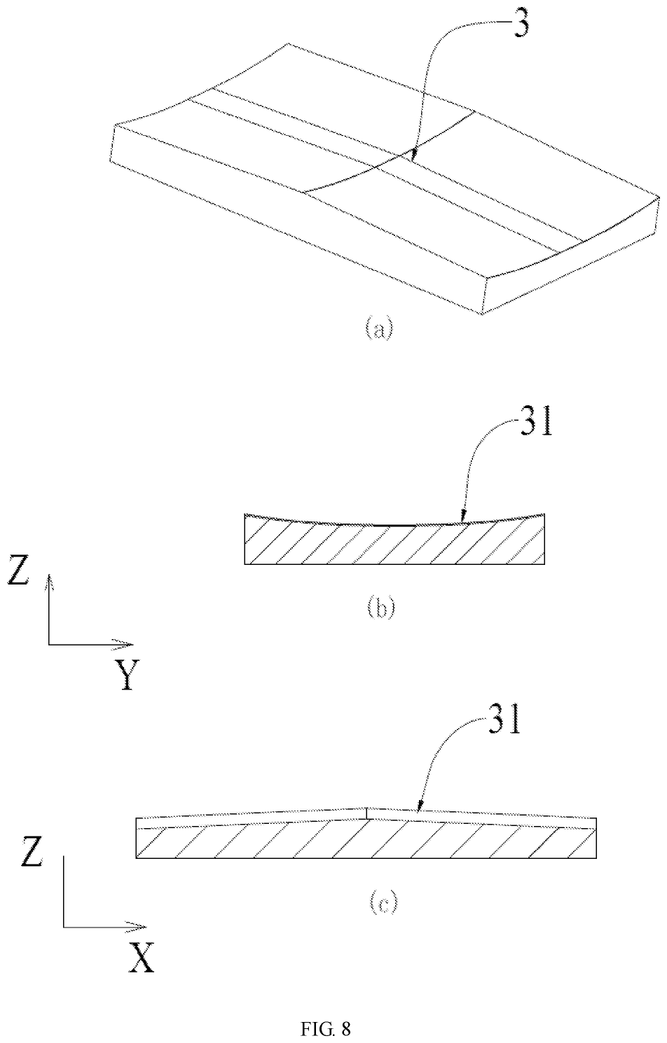

As shown in the structure of the reflector 3 in FIG. 8, the middle of the reflector 3 along the Y-axis direction is thin and the sides are thick, so as to cause the ultrasonic waves from the ultrasonic probe 1 to converge along the Y-axis direction, and the middle of the reflector 3 along the X-axis direction is thick and the sides are thin, so as to cause the ultrasonic waves from the ultrasonic probe 1 to disperse along the X-axis direction. And the reflector 3 of the above-described structure makes a different in the distribution of the ultrasonic waves in the X-axis direction and the Y-axis direction.

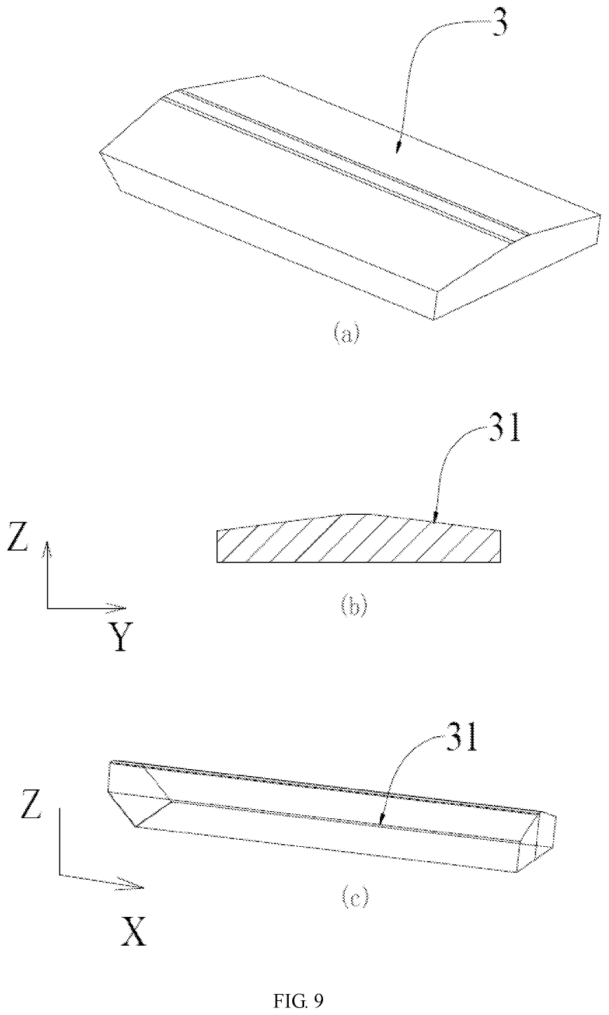

As shown in the structure of the reflector 3 in FIG. 9, the middle of the reflector 3 along the Y-axis direction is thick and the two sides are thin, so as to cause the ultrasonic waves from the ultrasonic probe 1 to diverge along the Y-axis direction, and the thickness of the reflector 3 along the X-axis direction does not change. The reflector 3 of the above structure causes the distribution of the ultrasonic waves to change in the Y-axis direction only, so as to cause the ultrasonic waves to diverge in the Y-axis direction.

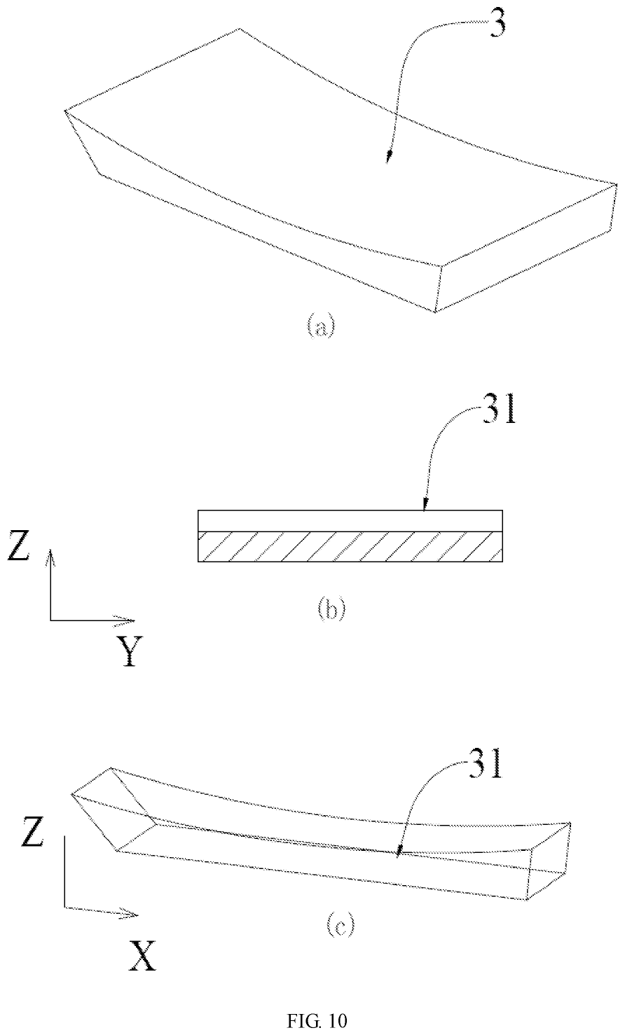

As shown in the structure of the reflector 3 in FIG. 10, the middle of the reflector 3 along the X-axis direction is thin and the two sides are thick, so as to allow ultrasonic waves from the ultrasonic probe 1 to converge along the X-axis direction; the thickness of the reflector 3 along the Y-axis direction does not change. The reflector 3 of the above structure causes the distribution of the ultrasonic waves to change in the X-axis direction only, so as to allow the ultrasonic waves to converge in the X-axis direction.

The above are only preferred embodiments of the present invention, and are not used to limit the protection scope of the present invention. Any modification, equivalent replacement or improvement within the spirit of the present invention is covered by the scope of the claims of the present invention.

What is claimed is:

1. An ultrasonic detection device, comprising:
an ultrasonic probe (1), which transmits ultrasonic waves and receives echoes;
a reflector (3), arranged spaced apart from the ultrasonic probe (1), which redistributes the energy of the ultrasonic wave to change the detection range of the ultrasonic wave.

2. The ultrasonic detection device as claimed in claim 1, wherein the ultrasonic detection device is used for detecting the flow of people in a space, and the ultrasonic device is arranged above the entrance and/or exit pathway of the space to detect the flow of people passing through; and after ultrasonic waves pass and reflected by the reflector (3), the detection range along the direction of flow of people matches the striding distance, the detection range perpendicular to the direction of flow of people matched the width of the entrance and/or exit pathway of the space.

3. The ultrasonic detection device as claimed in claim 2, wherein the space is a supermarket, a shopping mall, a store or a museum.

4. The ultrasonic detection device as claimed in claim 2, wherein the reflector (3) comprises a reflecting surface (31).

5. The ultrasonic detection device as claimed in claim 4, wherein the reflecting surface (31) comprises a convergence zone and/or a dispersion zone, the convergence zone causing the ultrasonic waves from the ultrasonic probe (1) to converge along an X-axis direction and/or a Y-axis direction, and the dispersion zone causing the ultrasonic waves from the ultrasonic probe (1) to disperse along the X-axis direction and/or the Y-axis direction.

6. The ultrasonic detection device as claimed in claim 4, wherein the reflector (3) is a reflecting plate, and along an X-axis direction and/or a Y-axis direction, the reflector (3) is thicker in the middle and thinner on both sides, so that the ultrasonic waves from the ultrasonic probe (1) can disperse along the corresponding direction.

7. The ultrasonic detection device as claimed in claim 4, wherein the reflector (3) is a reflecting plate, and along an X-axis direction and/or a Y-axis direction, the reflector (3) is thinner in the middle and thicker on both sides, so that the ultrasonic waves from the ultrasonic probe (1) can converge along the corresponding direction.

8. The ultrasonic detection device as claimed in claim 4, wherein the ultrasonic probe (1) is mounted along a horizontal direction, and the reflecting surface (31) is provided at an outward inclination with respect to the ultrasonic probe (1), so that the reflecting surface (31) reflects the ultrasonic waves coming from the ultrasonic probe (1) and then propagates them downwards.

9. The ultrasonic detection device as claimed in claim 6, further comprising an acoustic wave absorbing device (11), and the acoustic wave absorbing device (11) is arranged on the ultrasonic probe (1) or on the reflector (3) or in between.

10. The ultrasonic detection device as claimed in claim 1, wherein a mounting bracket (2) is also provided for mounting the ultrasonic probe (1).

11. The ultrasonic detection device as claimed in claim 10, wherein the reflector (3) is integrated with the mounting bracket (2).

12. The ultrasonic detection device as claimed in claim 7, further comprising an acoustic wave absorbing device (11), and the acoustic wave absorbing device (11) is arranged on the ultrasonic probe (1) or on the reflector (3) or in between.
